(19) United States
(12) Patent Application Publication
(10) Pub. No.: US 2006/0045498 A1
(43) Pub. Date: Mar. 2, 2006

(54) Lens-fitted photo film unit

(75) Inventors: Hirofumi Katsura, Minani-Ashigara-Shi (JP); Nobuhiko Kashiwagi, Minami-Ashigara-Shi (JP)

Correspondence Address: YOUNG & THOMPSON, 745 SOUTH 23RD STREET, 2ND FLOOR, ARLINGTON, VA, 22202, US

(73) Assignee: FUJI PHOTO FILM CO., LTD., MINAMI-ASHIGARA-SHI (JP)

(21) Appl. No.: 11/217,426

(22) Filed: Sep. 2, 2005

(30) Foreign Application Priority Data
Sep. 2, 2004 (JP) 2004-255356

(51) Int. Cl. G03B 15/03

(52) U.S. Cl. 396/6; 396/176

(57) ABSTRACT

In a lens-fitted photo film unit, a photo film is preloaded in the factory. The lens-fitted photo film unit includes a flash device for emitting flashlight from a xenon lamp by a discharge current of a main condenser. The flash device has guide number in the range from 2 to 5, and the color temperature of flashlight is in the range from 4500K to 5000K. The capacitance of the main condenser is from 8 μF to 10 μF.

### BACKGROUND OF THE INVENTION

1. Field of the Invention

The present invention relates to a lens-fitted photo film unit, and more particularly relates to a lens-fitted photo film unit having a flash device.

2. Description of the Related Art

The lens-fitted photo film units, in which an unexposed photo film is preloaded in the unit body provided with simple taking mechanisms, are commercially available. There are various types of the lens-fitted photo film units. There are lens-fitted photo film units such as one provided with interchangeable stop plates for appropriate exposure, one loading a high sensitivity photo film for photographing subject at a close distance at night without a flash device, and one provided with a flash device. The flash device includes a flashlight emitter for generating flashlight (illumination light) and a main condenser for supplying electricity to the flashlight emitter. In the lens-fitted photo film unit, when a flash photography mode is set, charging the main condenser is conducted. In synchronism with operation of a shutter blade on shooting, the main condenser is discharged, and flashlight is emitted to a subject from the flashlight emitter.

In the conventional lens-fitted photo film units, a flash device having the guide number of about 10 is used, so that the color temperature of flashlight emitted from the flash device is about 5500K. Therefore, a problem arises in that an unbalanced color photo is obtained when a subject is shot with a flashlight in a room illuminated by such as a fluorescent light, since there is a difference in color temperature between flashlight and fluorescent light which illuminates background. In order to solve the above problem, JP-A 2004-061538 discloses a lens-fitted photo film provided with a light reducing plate disposed in front of the flashlight emitter for reducing flashlight to prevent deterioration of color balance.

However, in the lens-fitted photo film unit which reduces flashlight, at least the light reducing plate is required, and number of parts, costs and assembly process are increased. Moreover, long time is required for charging, the main condenser to generate flashlight whose guide number is about 10 and color temperature is about 5500K, so that a shutter chance is likely to be missed. Furthermore, the main condenser having large capacitance is required for flashlight whose guide number is about 10, obstructing miniaturization of the lens-fitted photo film unit.

### SUMMARY OF THE INVENTION

An object of the present invention is to provide a lens-fitted photo film unit having a flash device with a simple structure that emits flashlight of low color temperature to a subject, to obtain a well-balanced photo.

To achieve the above and other objects, according to the present invention, a lens-fitted photo film unit is preloaded with a photo film whose ISO is equal to or more than 1600, and is provided with a flash device having guide number from 2 to 5, to emit a flashlight whose color temperature is from 4500K to 5000K. A well-balanced photo can be obtained by reducing the difference in color temperature between a main subject emitted from a flashlight of low color temperature and a background illuminated by an artificial illumination.

For the flashlight whose color temperature is from 4500K to 5000K, the guide number will be small, and thus a small-sized main condenser having capacitance from 8 μF to 18 μF can be used. This is useful for shortening charging time, miniaturizing the lens-fitted photo film unit, and lowering the production cost. Moreover, the production cost can be lowered since a light reducing plate is not required.

### BRIEF DESCRIPTION OF THE DRAWINGS

The above objects and advantages of the present invention will become apparent from the following detailed description of the preferred embodiments of the invention when read in conjunction with the accompanying drawings, in which:

FIG. 1 is an external perspective view illustrating a lens-fitted photo film unit according to the present invention with an operation knob set at a first position;

FIG. 2 is an external perspective view illustrating the lens-fitted photo film unit according to the present invention with the operation knob set at a second position;

FIG. 3 is an external perspective view illustrating the lens-fitted photo film unit according to the present invention with the operation knob set at a third position;

FIG. 4 is an exploded perspective view of the lens-fitted photo film unit;

FIG. 5 is an exploded perspective view of a periphery of a light shielding box illustrating a shutter mechanism, a stop changeover mechanism, and a shutter speed changeover mechanism;

FIG. 6 is an enlarged perspective view of a flash device; and

FIG. 7 is a block diagram schematically illustrating electric structure of the flash device.

### DETAILED DESCRIPTION OF THE PREFERRED EMBODIMENT (S)

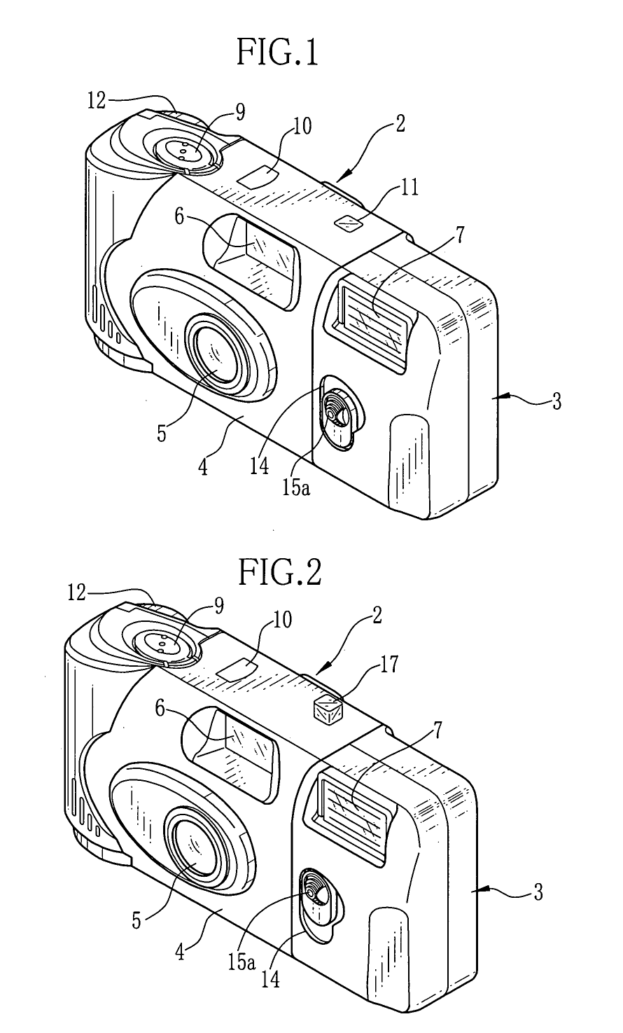

In FIGS. 1 to 3, a lens-fitted photo film unit 2 includes a unit body 3 having an exposure mechanism, and an outer label 4 wound around the periphery of the unit body 3. A front face of the unit body 3 is provided with such as a taking lens 5, a viewfinder 6, a flashlight emitter 7. An upper face of the unit body 3 is provided with such as a shutter button 9, a counter window 10 for displaying the number of photographing frames available, a signal opening 11 for which a signaling member 17 protrudes for displaying charging state of the flash device. A winding wheel 12 for winding the photo film partially appears in a rear face of the unit body 3.

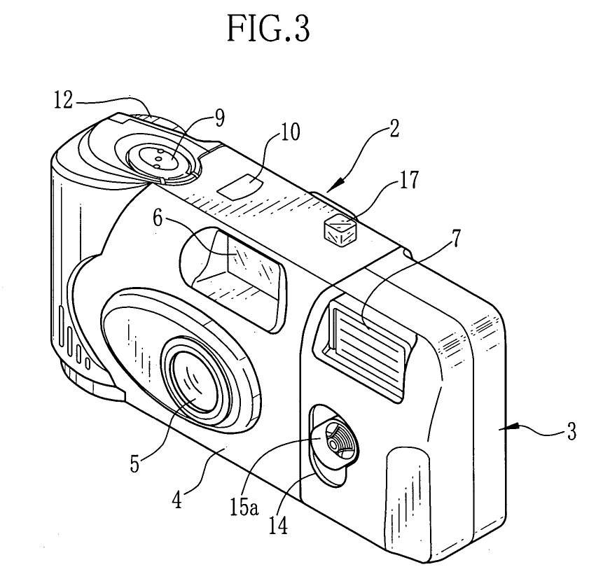

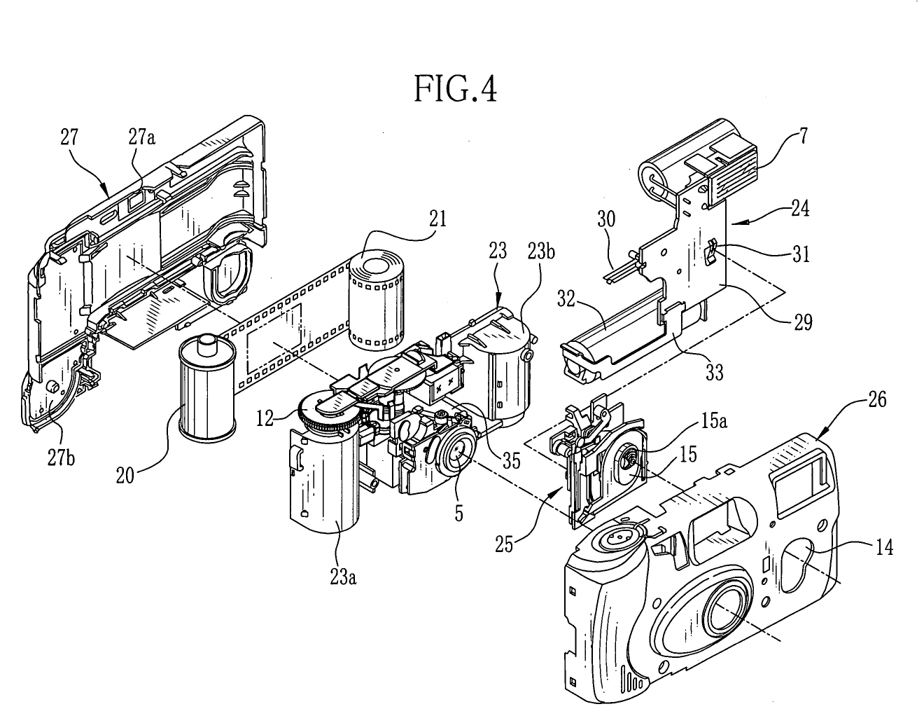

In an operation opening 14 formed on the front face of the unit body 3, an operation knob 15a is movably disposed. The operation knob 15a is a part of a flash-operating member 15 (see FIG. 4), and moves among a first position placed on the downside of the operation opening 14, a second position to be slid up from the first position as illustrated in FIG. 2, and a third position to be rotated from the second position as illustrated in FIG. 3.

When the operation knob 15a is set in the first position, a first photography mode with a small stop and a high shutter speed is selected.

When the operation knob 15a is set in the second position, a second photography mode with flashlight emission, a small stop, and a high shutter speed is selected. When the operation knob 15a is set in the third position, a third photography mode with flashlight emission, a large stop and a low shutter speed, is selected. When the operation knob 15a is set in the second or third position, the signaling member 17 projects from the upper face of the lens-fitted photo film unit 2 to inform the users of the charging state of the flash device. The signaling member 17 exteriorly guides the light of a light emitting diode (LED) provided inside the lens-fitted photo film unit 2, so that the user can be informed of the completion of charging the flash device, for example by blink of light emitted from the signaling member 17.

In FIG. 4, the unit body 3 includes a cassette 20 of 135 type, a body base 23, a flash device 24, a mode change mechanism 25, a front cover 26 and a rear cover 27. The body base 23 is loaded with an unexposed photo film 21 taken from the cassette 20. The flash device 24 is secured to the front face of the body base 23. The mode change mechanism 25 changes the photography modes according to the movement of the flash operating member 15. The front and rear covers 26 and 27 are respectively attached to the front and the rear faces of the body base 23. A color negative film of high sensitivity, ISO 3200, is used for the photo film 21. Moreover, a color negative film of ISO equal to or mode than 1600 is acceptable, for example, ISO 1600, or 6400 is also acceptable.

The flash device 24 includes such as a printed circuit board 29 having electric elements to form a flash circuit and the flashlight emitter 7 including a flash discharge tube, a reflector, and a diffusion plate. The printed circuit board 29 is provided with a synchronizing switch 30, a charging switch 31 and a battery holder 33. The synchronizing switch 30 is turned on in synchronism with the shutter blade to generate flashlight. The charging switch 31 is turned on and off by the movement of the flash-operating member 15. The battery holder 33 holds a battery 32 and is also used as terminal segments.

A light shielding box 35 is formed at the center on the front of the body base 23, for shielding the photography optical path between the taking lens 5 and the photo film 21. Both sides of the light shielding box 35 are provided with a cassette chamber 23a for containing the cassette 20 and a film roll chamber 23b for containing the photo film 21. Various elements are disposed on the periphery of the light shielding box 35, such as a shutter mechanism, a shutter release mechanism, a film winding mechanism, a film-winding stop mechanism, a film counting mechanism, a stop changing mechanism for changing the stop, a shutter-speed changing mechanism for changing the shutter speed, the taking lens 5, and a viewfinder optical system.

The winding wheel 12 is attached to the upper side of the cassette chamber 23a in a rotatable manner, so that an exposed photo film can be wound up in the cassette 20 by rotation of the winding wheel 12 after shooting. A count plate proceeded by one step according to rotation of the winding wheel 12 is provided on the side of the winding wheel 12 to display the number of photographing frames available.

The rear cover 27 is attached to cover the back of the body base 23. The rear cover 27 is provided with a rear viewfinder window 27a and a pull-tab type bottom lid 27b for covering the bottom of the cassette chamber 23a in a light-tight fashion. The bottom lid 27b is opened when the cassette 20 housing the exposed photo film 21 is taken out. The front cover 26, formed with such as an opening for exposing the taking lens 5, and the operation opening 14 for exposing the operation knob 15a in a slidable manner, is attached to cover the front of the body base 23.

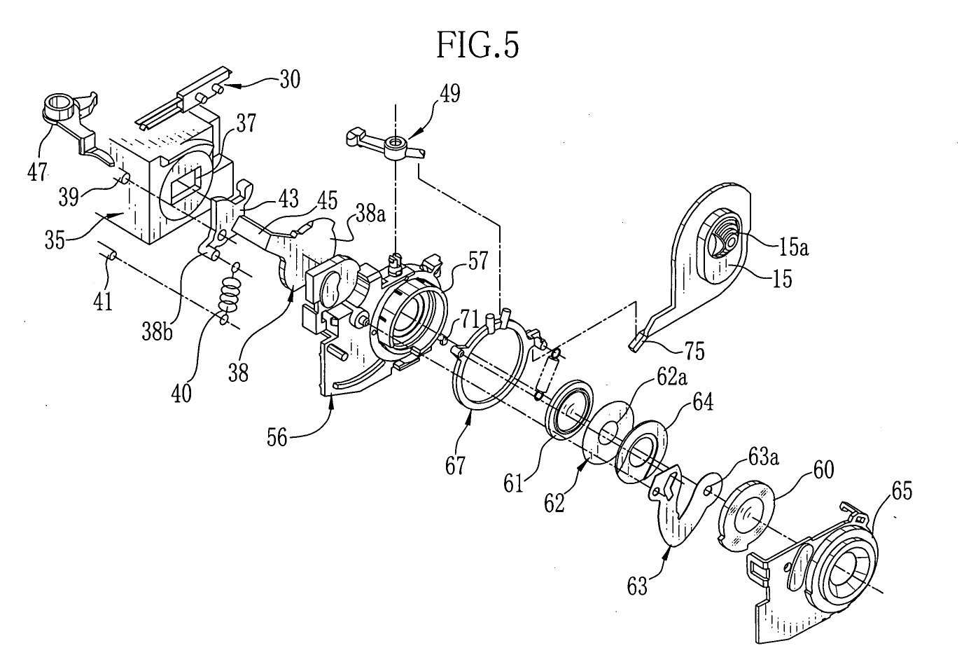

In FIG. 5, a shutter mechanism includes a shutter blade 38, a shutter drive lever 47, and a spring 40. The front face of the light shielding box 35 is formed with an exposure opening 37, and the shutter blade 38 is swingablly supported by a support pin 39 which is provided at the side of the light shielding box 35. An edge 38a of the shutter blade 38 can move between a close position for closing the exposure opening 37 and an open position for opening the exposure opening 37. A projection 38b formed on the shutter blade 38 catches one end of a spring 40, and an engaging pin 41 formed on the body base 23 catches the other end of the spring 40. Thereby, the shutter blade 38 is biased by the spring 40 to be kept in the close position.

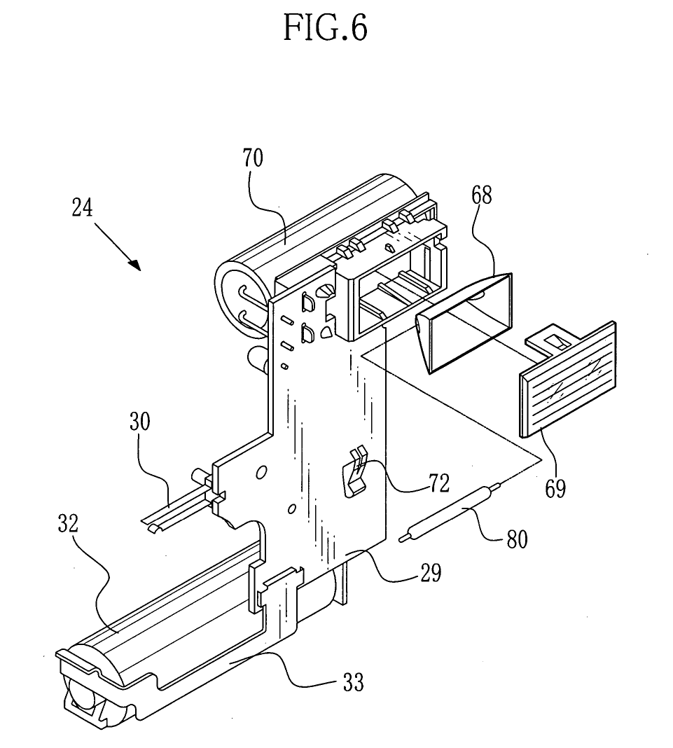

The shutter drive lever 47 can rotate between a charging position and a releasing position, and is set at the charging position by a shutter charge mechanism working with film winging action. When the shutter is released, the shutter drive lever 47 rotates toward a releasing position from a charging position. The shutter drive lever 47 kicks the shutter blade 38 to move the edge 38a of the shutter blade 38 to the open position. When the exposure opening 37 is fully opened, the shutter blade 38 pushes one contact segment of the synchronizing switch 30 to contact with the other one, turning on the synchronizing switch 30. In the situation the flash switch (see FIG. 6) is turned on, when the synchronizing switch 30 is turned on, flashlight is emitted from the flashlight emitter 7.

The upper side of a lens holder 56 is provided with a shutter speed changeover mechanism 49 in a rotatable manner for changing shutter speed. The shutter speed changeover mechanism 49 is set at a high speed shutter position or at a low speed shutter position. When the shutter speed changeover mechanism 49 is set at the high speed shutter position, moving distance of the shutter blade 38 is short and returned to the close position in a short period of time. When the shutter speed changeover mechanism 49 is set at the low speed shutter position, moving distance of the shutter blade 38 is long and returned to the close position in a relatively long period of time. When the flash-operating member 15 is set at the first or second position, the shutter speed changeover mechanism 49 is set at the high-speed shutter position. When the flash-operating member 15 is set at the third position, the shutter speed changeover mechanism 49 is set at the low speed shutter position. When the shutter speed changeover mechanism 49 is set at the high speed shutter position, the shutter speed is, for example 1/120 second. When the shutter speed changeover mechanism 49 is set at the low speed shutter position, the shutter speed is, for example 1/45 second. It is noted that high shutter speed and low shutter speed may be set at suitable values.

First and second lenses 60 and 61 are fit in a lens barrel 57 formed on the lens holder 56. Both a large stop plate 62 formed with a large stop aperture 62a, and a stop changeover plate 63 formed with a small stop aperture 63a which is smaller than the large stop aperture 62a are disposed between the first and second lenses 60 and 61. A spacer 64 is disposed between the large stop plate 62 and the stop changeover plate 63. A protection cover 65 is put on the lens barrel 57.

A stop changeover ring 67 is fit around the periphery of the lens barrel 57. The stop changeover ring 67 puts the stop changeover plate 63 in and out of the photographic optical path, and thereby moves the small stop aperture 63a between a small stop position where the small stop aperture 63a is positioned in front of the large stop aperture 62a and a large stop position where the small stop aperture 63a is moved away from the front of the large stop aperture 62a. When the flash-operating member 15 is set at the first or second position, the stop changeover plate 63 is positioned at the small stop position. With rotation of the flash-operating member 15 to the third position, the stop changeover ring 67 rotates, to move the stop changeover plate 63 to the large stop position. The f-number is set at, for example f/14 in a small stop state, and f/4 in a large stop state. It is noted that the f-numbers in a small stop state and a large stop state are not limited to the above, and they may be changed to suitable values.

In FIG. 6, the flash device 24 is set to have for example, the guide number of 2.0, and the color temperature of 4500K for flashlight. The flashlight emitter 7 includes a flash discharge tube such as a xenon lamp 80, a reflector 68 for forwardly reflecting light emitted from the xenon lamp 80, a protector 69 (diffusion plate) for protecting the xenon lamp 80 and the reflector 68 and having light diffusion function. A main condenser 70 is provided on the back of the flashlight emitter 7. The main condenser 70 is an electrolytic condenser, whose electric capacity is 10 microfarad (μF). The print circuit board 29 is provided with such as a flash switch 72 which is tuned on when the flash-operating member 15 is set at the second or the third position. When the flash switch 72 is turned on, charging the main condenser 70 is conducted, and the charging state is displayed by blink of the signaling member 17. When the synchronizing switch 30 is turned on while the flash switch 72 is ON, electrical charge in the main condenser 70 is supplied to the xenon lamp 80 in the flashlight emitter 7 at a stretch, to emit flashlight having the color temperature of 4500K. The protector 69 made of a color temperature converting filter to have a color temperature convert function, may be used for lowering the color temperature of the flashlight.

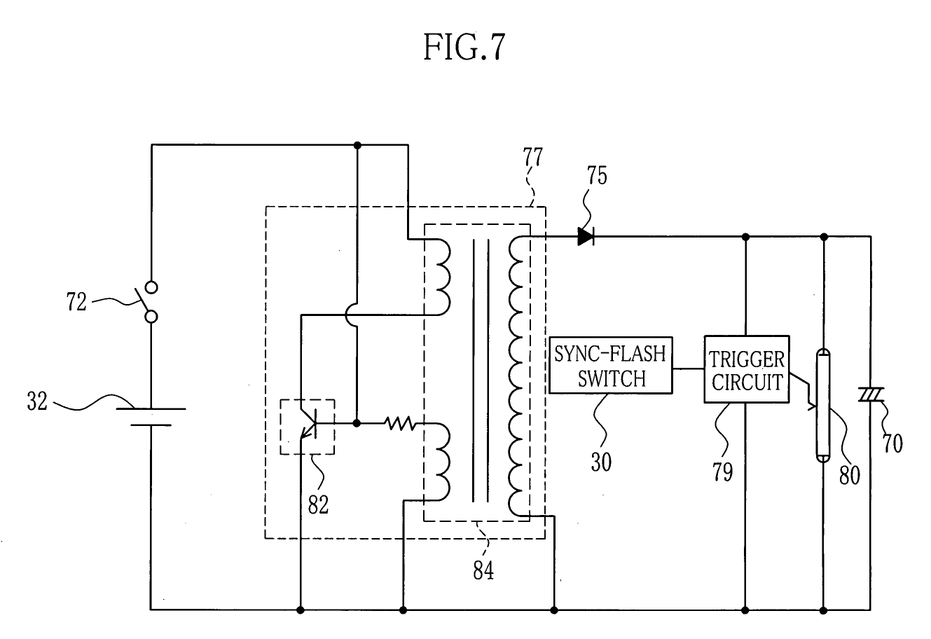

In FIG. 7, the flash device 24 is provided with an oscillation circuit for boosting the voltage 77 for boosting of the battery 32 to charge the main condenser 70 up to 350V via a rectifier diode 75. The oscillation circuit for boosting the voltage 77 also charges a trigger condenser in a trigger circuit 79 to store trigger voltage required for emitting the xenon lamp 80. The oscillation circuit for boosting the voltage 77 includes such as an oscillation transistor 82 and an oscillation transformer 84.

The operation of the above embodiments are described now. When photographs are taken outside in the daytime, the operation knob 15a of the flash-operating member 15 is set at the first position, and the winding wheel 12 is rotated till it is locked, to charge the shutter. The shutter drive lever 47 rotates to the release position from the charge position in response to the press of the shutter button 9, and the shutter blade 38 is kicked to expose the photo film 21 at high shutter speed of 1/120 second. In this case, flashlight is not generated since the flash device is in the OFF state.

When photographs are taken indoors, the operation knob 15a of the flash-operating member 15 is set at the second position, to select a second photography mode. In the second photography mode, the flash switch 72 is turned on to charge the main condenser 70. Simultaneously with open and close of the shutter blade by the press of the shutter button 9, flashlight of the color temperature 4500K is emitted from the flash device 24. Thereby, a flash photograph is taken at high shutter speed of 1/120 second. In the first and second photography modes, the stop changeover plate 63 is set in the photography optical path, and the small stop aperture 63a sets the f-number to f/14.

When photographs are taken at dark place at night, the operation knob 15a of the flash-operating member 15 is set at the third position, to select a third photography mode. When the flash-operating member 15 rotates to the third position from the second position, the stop changeover plate 63 is retreated from the photography optical path to set the f-number to f/4. The main condenser 70 is being charged since the flash switch 72 is kept ON. When the shutter button 9 is pressed, flashlight of the color temperature 4500 K is emitted and a photograph is taken at the low shutter speed of 1/45 second.

With both the flash device 24 whose guide number is 2.0 and the color temperature of flashlight is 4500K, and the photo film 21 of ISO 3200, a photo having less difference in the color temperature between a main subject emitted by flashlight and a background illuminated by a room illumination can be obtained in the second and third photography modes. Moreover, it is possible to eliminate the use of the light reducing plate and the driving mechanism thereof required for lowering the color temperate of flashlight in the conventional lens-fitted photo film units. Furthermore, it is possible to simplify the structure of the lens-fitted photo film unit and to reduce the cost with the high performance kept, by providing the main condenser 70 having smaller capacitance than the conventional ones. Still furthermore, miniaturization of the main condenser 70 can be expected, and thereby the lens-fitted photo film unit can be thinner.

The aforementioned embodiments describe that the main condenser 70 of 10 μF is charged at about 350V, but the color temperature of flashlight can be lowered by lowering the charging voltage of the main condenser. It is possible to lower the color temperature of flashlight, for example, by supplying the voltage of 310V from the main condenser, thereby a well-balanced photo in the color temperature between the main subject and the background can be obtained.

Moreover, in the aforementioned embodiments, the stop and the shutter speed are changed according to the operation of the flash-operating member, but only the stop may be changed. Therefore, it is possible to eliminate the shutter speed changeover mechanism, thereby to reduce the cost of the lens-fitted photo film unit and to simplify the assembly thereof.

Furthermore, in the aforementioned embodiments, the first, second and third photography modes are provided, but it may be possible to provide two photography modes, a normal photography mode for non-flash photographs, and a flash photography mode for flash photographs. When the flash photography mode is selected, charging the main condenser is conducted and the f-number changes from large to small. Therefore, in the lens-fitted photo film unit provided with two photography modes, it is expected to simplify the structure of the lens-fitted photo film unit, to obtain a well-balanced photo and to lower the cost.

Still furthermore, the aforementioned embodiments describe that the f-number is f/4, the main condenser is 10 μF, and the guide number is 2.0, but the present invention is not limited to these. It may be possible to use, for example, a photo film of ISO 3200, a stop changeover plate formed with an aperture of f/5.6, and a main condenser having electric capacity of 15 μF. In this case, the guide number of the flash device is 2.8. With this combination, flashlight of the color temperature 4800K is emitted. Also in this case, it is possible to obtain a photo with less color difference between the subject emitted by flashlight and the background.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A lens-fitted photo film unit comprising:
a preloaded photo film having ISO sensitivity being equal to or more than 1600;
a flash device for emitting flashlight to a subject, said flash device having guide number in the range from 2 to 5, and color temperature of said flashlight being in the range from 4500K to 5000K.

2. A lens-fitted photo film unit according to claim 1, wherein said flash device includes a main condenser for charging electrical charge, and a flash discharge tube for emitting said flashlight when said main condenser is discharged.

3. A lens-fitted photo film unit according to claim 2, wherein capacitance of said main condenser is in the range from 8 μF to 18 μF.

4. A lens-fitted photo film unit according to claim 3, wherein said main condenser is an electrolytic capacitor.

5. A lens-fitted photo film unit according to claim 3, further including a protector placed in front of said flash discharge tube, said protector having a function of changing color temperature of said flashlight.

6. A lens-fitted photo film unit according to claim 3, further including:
a flash switch for changing said flash device to one of ON and OFF states, said flashlight being emitted in said ON state, and being not emitted in said OFF state;
a stop mechanism changeable to one of a large stop state and a small stop state;
a shutter mechanism changeable to one of high shutter speed and low shutter speed; and
a changing member for selecting one of first, second, and third modes, said OFF state, said small stop state and said high shutter speed being set in said first mode, said ON state, said small stop state and said high shutter speed being set in said second mode, and said ON state, said large stop state and said low shutter speed being set in said third mode.
